(19) United States
(12) Patent Application Publication
(10) Pub. No.: US 2023/0019246 A1
(43) Pub. Date: Jan. 19, 2023

(54) TIME-OF-FLIGHT IMAGING CIRCUITRY, TIME-OF-FLIGHT IMAGING SYSTEM, AND TIME-OF-FLIGHT IMAGING METHOD

(71) Applicant: Sony Semiconductor Solutions Corporation, Kanagawa (JP)

(72) Inventor: Manuel AMAYA BENITEZ, Stuttgart (DE)

(73) Assignee: Sony Semiconductor Solutions Corporation, Kanagawa (JP)

(21) Appl. No.: 17/783,275

(22) PCT Filed: Dec. 22, 2020
(86) PCT No.: PCT/EP2020/087619

§ 371 Date: Jun. 8, 2022

(30) Foreign Application Priority Data
Dec. 23, 2019 (EP) 19219412.4

(51) Int. Cl. G01S 7/4863; G01S 17/894

(52) U.S. Cl. CPC G01S 7/4863; G01S 17/894

(57) ABSTRACT

The present disclosure generally pertains to time-of-flight imaging circuitry configured to: control a set of readout channels for an imaging element for obtaining a set of events representing a set of light pulses captured in the imaging element, wherein the controlling includes: a first detection of the set of events in a first readout channel of the set of readout channels; and a second detection in a second readout channel, wherein the second detection starts a predetermined time after a start of the first detection for detecting a subset of the events.

### TECHNICAL FIELD

The present disclosure generally pertains to a time-of-flight imaging circuitry, a time-of-flight imaging system, and a time-of-flight imaging method.

### TECHNICAL BACKGROUND

Generally, time-of-flight systems are known. For example, in a case of direct time-of-flight (dToF), a roundtrip delay of the light, i.e. a time the light needs from an emission to a detection, is (directly) measured.

Typically, in such systems, a pulsed light source is provided, configured to emit a light pulse, whose roundtrip delay is measured. After the measurement, a subsequent light pulse can be emitted for a subsequent measurement. Hence, a statistically significant number of light pulses can be emitted and a distance can be significantly determined.

Although there exist time-of-flight systems, it is generally desirable to provide a time-of-flight imaging circuitry, a time-of-flight imaging system, and a time-of-flight imaging method.

### SUMMARY

According to a first aspect the disclosure provides a time-of-flight imaging circuitry configured to: control a set of readout channels for an imaging element for obtaining a set of events representing a set of light pulses captured in the imaging element, wherein the controlling includes: a first detection of the set of events in a first readout channel of the set of readout channels; and a second detection in a second readout channel, wherein the second detection starts a predetermined time after a start of the first detection for detecting a subset of the events.

According to a second aspect the disclosure provides a time-of-flight imaging system comprising: a light source; control circuitry configured to control the light source to emit a set of light pulses; and time-of-flight imaging circuitry configured to: control a set of readout channels for an imaging element for obtaining a set of events representing a set of light pulses captured in the imaging element, wherein the controlling includes: a first detection of the set of events in a first readout channel of the set of readout channels; and a second detection in a second readout channel, wherein the second detection starts a predetermined time after the first detection for detecting a subset of the events.

According to a third aspect the disclosure provides a time-of-flight imaging method comprising: controlling a set of readout channels for an imaging element for obtaining a set of events representing a set of light pulses captured in the imaging element, wherein the controlling includes: a first detection of the set of events in a first readout channel of the set of readout channels; and a second detection in a second readout channel, wherein the second detection starts a predetermined time after the first detection for detecting a subset of the events.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 depicts a time-of-flight imaging method according to the present disclosure;

FIG. 2 depicts an accumulated histogram generated with the time-of-flight imaging method of FIG. 1;

FIG. 3 depicts a time-of-flight imaging method as it is generally known in the art;

FIG. 4 depicts a further embodiment of a time-of-flight imaging method according to the present disclosure in a block diagram;

FIG. 5 depicts a time-of-flight imaging system according to the present disclosure in a block diagram;

FIG. 6 illustrates a further embodiment of a time-of-flight imaging system according to the present disclosure;

FIG. 7 depicts a time-of-flight imaging system according to the present disclosure in a block diagram; and

FIG. 8 depicts a time-of-flight imaging system, as it is known in the art, in a block diagram.

### DETAILED DESCRIPTION OF EMBODIMENTS

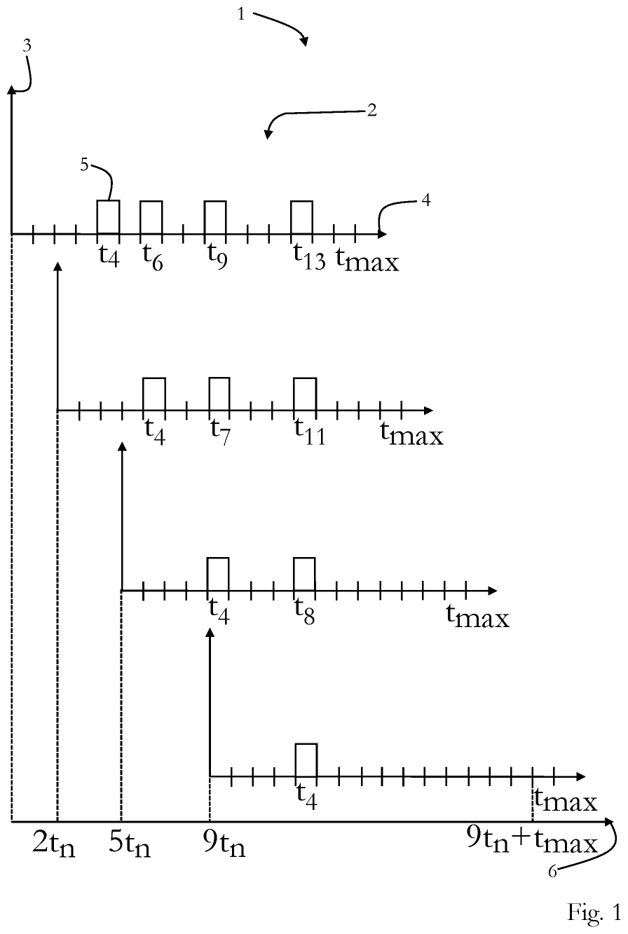

Before a detailed description of the embodiments under reference of FIG. 1 is given, general explanations are made.

As mentioned in the outset, dToF (direct time-of-flight) systems are generally known. In such systems, which may be configured as cameras a depth map may be obtained by measuring the time-of-flight of light, which is emitted from the camera to the scene and being reflected at the scene and subsequently detected.

However, it has been recognized that in existing systems, a noise may be too high, such that a peak indicating the depth may not be discriminated from the noise in a resulting signal.

Such noise may, for example, be based on active light, ambient light, system noise, and the like.

Therefore, it may be desirable in some instances to increase a height of a peak or to improve a signal-to-noise ratio.

Typically, an array of macro pixels (or superpixels) may be envisaged including a plurality of sub-pixels, of which each may be configured to perform such a measurement. Also, a photon counting unit may be referred to as a sub-pixel.

It has, however, been recognized that by adapting a readout of the macro pixel or of each sub-pixel, a speed of a time-of-flight measurement may be increased.

By increasing a speed, a motion blur may be, on the other hand, decreased.

A motion blur can, for example, be generated when a ToF system moves between an acquisition of two frames (i.e. between two measurements) and/or when an object or a scene moves.

For example, this may be the case when the ToF system is integrated in a mobile phone, a handheld camera, and the like, such that it is not a steady system, and an unintentional shaking may be a basis for a movement.

Moreover, an intentional movement may exist, for example in a case of a spinning and/or a scanning of a LiDAR system (e.g. in an automotive area), which may be used for increasing a field of view of the LiDAR system.

Therefore, it may be desirable, in some instances, to decrease a time between two frames, such that a motion blur may be reduced.

Moreover, in some instances, it may be desirable to decrease an effect of a motion blur. In existent systems, histograms of each macro pixel are typically mixed in an accumulated histogram. However, this may lead to a deterioration of the resulting depth information since the depth information of each macro pixel may be different from another macro pixel since, for example a different field of view of a scene may be imaged by each macro pixel.

Moreover, merging the histograms of different macro pixels is typically time-inefficient and a postprocessing for compensating for a motion blur may need a high amount of processing/computational power (and therefore also energy), since for such a postprocessing an information of motion sensors may be utilized for determining the respective positions of different macro pixels at different time instances.

Hence, it has been recognized that it may be desirable in some instances to provide an efficient motion robustness in a time-of-flight imaging system.

It has also been recognized that it may be desirable in some instances to optimize a depth map acquisition.

Moreover, it has been recognized that it may be desirable in some instances to not increase costs of a time-of-flight imaging system, which may arise by providing additional hardware.

Therefore, some embodiments pertain to a time-of-flight imaging circuitry configured to: control a set of readout channels for an imaging element for obtaining a set of events representing a set of light pulses captured in the imaging element, wherein the controlling includes: a first detection of the set of events in a first readout channel of the set of readout channels; and a second detection in a second readout channel, wherein the second detection starts a predetermined time after a start of the first detection for detecting a subset of the events.

The time-of-flight imaging circuitry may be any circuitry configured to process a time-of-flight signal, such as a CPU (Central Processing Unit), GPU (Graphic processing unit), FPGA (field programmable gate array), and the like, wherein also multiple of the named elements may be coupled to form a time-of-flight imaging circuitry according to the present disclosure.

The set (i.e. at least two) of readout channels may be configured of time-to-digital converters (TDC), which may each be coupled to a gate (or multiple gates) of the imaging element, wherein the present disclosure is not limited to the case of TDCs, as any circuitry for reading out a time-of-flight signal may be envisaged.

The set of readout channels may be provided to the imaging element, i.e. (loosely) coupled to the imaging element, such that they are not included in the imaging element, whereas, in other embodiments, the set of readout channels may be included in the imaging element. In some embodiments, a subset of the readout channels may be included in the imaging element, wherein another subset may be not included in the imaging element.

The imaging element may be based on a known imaging technology, such as CMOS (Complementary Metal Oxide Semiconductor), CCD (Charge Coupled Device) and may include at least one SPAD (Single Photon Avalanche Diode), such that a detection of events can be carried out, as will be discussed further below.

The imaging element may be configured of at least one pixel. For example, in the case of one pixel, the set of readout channels may be provided to the one pixel, whereas in the case of multiple pixels (also referred to as a macro pixel), each pixel of the macro pixel may have a readout channel. However, in some embodiments, a subset of pixels of a macro pixel may have multiple readout channels and another subset may have one readout channel.

The controlling of the set of readout channels may include a timing of a readout, such that an imaging signal being provided in response to the set of light pulses may be read out in a time-shifted manner in the set of readout channels.

For example, the set of light pulses may include two light pulses, which are emitted (and therefore captured) one after the other. In such an example, two readout channels may be provided, wherein a readout of the first readout channel may be timed such that the two light pulses (or the events representing the light pulses) are detect in a first detection. A readout of the second readout channel (i.e. a second detection) may be timed (or delayed with respect to the first detection) such that the second light pulse is detected.

An event may be generated in response to a capturing of a light pulse (e.g. one or more photons of a light pulse) in the imaging element. For example, a photoelectric conversion process may be triggered in response to light captured in the imaging element, such that the event may be based on such a photoelectric conversion. In embodiments, in which the imaging element includes a SPAD, an event may be based on a photon avalanche generated in response to captured light, as it is generally known.

A detected event which is based on a first light pulse is in the art entered into a bin memory, which is typically represented by a first histogram. The bin memory may typically be reset after the event detection, such that a second light pulse may trigger an event (or multiple events) which may be entered in the bin memory after the reset, such that a second histogram is generated.

The first and the second histogram are typically merged after the detection is finished, such that an accumulated histogram may be created.

However, since according to the present disclosure the same event may be detected multiple times, and since multiple light pulses are detected in the first detection, which are represented by different events, every detected event, disregarding in which of the first and the second detection it is detected, may be entered in the same histogram, or, in other words, corresponding bins of a bin memory may be updated simultaneously.

For example, each readout channel may have or be coupled to a clock (or to multiple clocks), such that an internal time is provided for each readout channel. Then, the first readout channel may detect a first event being representative of the first light pulse at a first internal time and a second event being representative of the second light pulse at a second internal time. Moreover, the second readout channel may detect a first event being representative of the second light pulse at a first internal time.

The start of the second detection may be a predetermined time after the start of the first detection, wherein the predetermined time may correspond to a delay between the first and the second light pulse. Until the start of the second detection, the second readout channel may be “dead”, which means that it may not recognize any events until the second detection (time interval) starts.

Hence, the first internal time of the second readout channel may correspond to the first internal time of the first readout channel.

Thereby, the same bin of the bin memory may be updated based on the first detection and based on the second detection, wherein, additionally another bin may be updated based on the first detection.

It should be noted that the present disclosure is not limited to a first and a second readout channel since any number of readout channels and light pulses may be envisaged, which may not necessarily correspond in their numbers.

For explanatory purposes, FIG. 1 depicts a time-of-flight imaging method 1 in the case of four light pulses being detected in a first to a fourth detection, without limiting the present disclosure in that regard.

In FIG. 1, there are shown four histograms 2 having on an ordinate 3 a number of events and on an abscissa 4 a time.

Events 5 are depicted at multiple time instances tₙ, wherein n is a number above zero, without limiting the present disclosure in that regard.

It should be noted that, for explanatory purposes, events caused by system noise and/or ambient light are not depicted.

Moreover, the respective starts of the first to the fourth detection are timed according to a master clock signal 6, such that predetermined time intervals between the detections is defined, which correspond to predetermined time intervals between the light pulses. Each detection stops at a time instance tₘₐₓ.

In the first (upper) histogram, a first detection of events 5 is illustrated at time instances t₄, t₆, t₉, and t₁₃, wherein these time instances are based on an internal clock of a first readout channel.

It should be noted that, for explanatory purposes, the bins of the histograms are depicted to have roughly the same size.

However, the present disclosure is not limited in that regard, and, depending on the application, a person skilled in the art may adapt a bin size. For example, a bin size may be based on a delay of a light source, and the like.

Returning to FIG. 1, the events in the first histogram represent the four light pulses being detected subsequently.

In the second histogram, three events are detected which represent the second to fourth light pulse. This means that the second light pulse is represented by an event at an internal time instance t₄, the third light pulse is represented by an event at an internal time instance t₇, and the fourth light pulse is represented by an event at an internal time instance t₁₁.

The event at the internal time instance t₄ of the second readout channel corresponds to the event at the internal time instance t₆ of the first readout channel, i.e. both events represent the second light pulse.

Hence, the event representing the first light pulse is not detected in the second readout channel anymore.

In the third histogram, the first and the second light pulse are not represented, and in the fourth histogram, only the last light pulse is represented.

In this embodiment, more generally, the time distance between the light pulses corresponds to the time shifts or delays, i.e. the predetermined time between the starts of the detections of the readout channels. For instance, the time interval between the first and the second light pulse corresponds to the time interval between the start of the first detection of the first readout channel and the start of the second detection of the second readout channel (the “second” detection corresponding to the start of the detection of the second readout channel), the time interval between the second and the third light pulse corresponds to the time interval between the start of the second detection of the second readout channel and the start of the third detection of the third readout channel, etc.

As discussed above, these histograms are only depicted for explanatory purposes and according to the present disclosure, there may only be one histogram generated, in which all the events 5 are accumulated, or, in other words: one bin memory may be updated simultaneously for each readout channel.

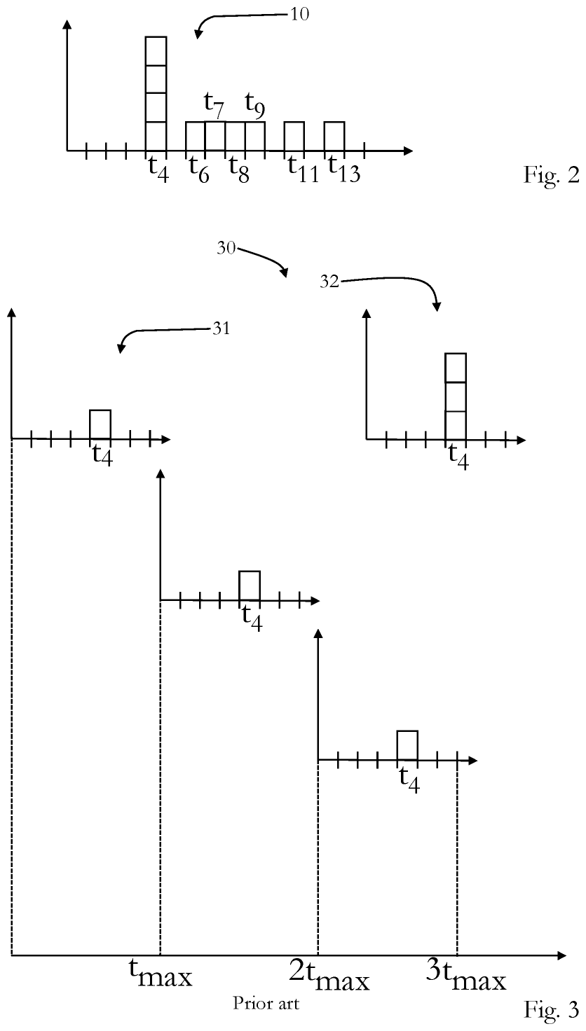

In such a bin memory, the events may be accumulated according to the internal time instances of the respective readout channels, which is depicted in FIG. 2.

FIG. 2 depicts an accumulated histogram 10, wherein all events are accumulated according to the internal time of each readout channel.

From this histogram 10, it can be concluded that the emitted light needs the time t₄ to travel to the object, being reflected and then detected. Hence, the distance (or depth) d to the object may be determined according to d=c*t₄/2, wherein c is the speed of light.

It should be noted that, according to this embodiment, a noise of the signal is increased, but compared to the peak at t₄, the noise is sufficiently small, such that the depth may be determined without an error being caused due to the noise.

However, performing a depth measurement as discussed with respect to FIGS. 1 and 2, a measurement speed may be increased compared to known methods. For example, in this embodiment a measurement time may last for tₘₐₓ+Σtₙ=tₘₐₓ+(2+3+4)*tₙ=tₘₐₓ+9*tₙ.

Compared to this, a time-of-flight measurement as it is known in the art may last for 4*tₘₐₓ, if four light pulses are detected, as will be discussed with respect to FIG. 3.

FIG. 3 depicts a time-of-flight imaging method 30 as it is generally known in the art. For illustrational purposes only, three (shorter) histograms 31 are depicted. However, each histogram may be generated in a similar amount of time as the histograms of FIG. 1, i.e. only the axes are depicted shorter, but tₘₐₓ may have the same value.

Each time after tₘₐₓ is reached, a bin memory is reset.

Each of the histograms 31 includes an event being representative of a light pulse. For example, the first (upper) histogram is generated based on a first measurement, which lasts for the time tₘₐₓ. The same applies to the second and third measurement (and for a fourth measurement which is not depicted), such that the total measurement time is 3tₘₐₓ (or 4tₘₐₓ for four measurement). Based on such a measurement, an accumulated histogram 32 is typically generated, which also has a peak at t₄, such as the peak of the accumulated histogram 10 according to the present disclosure. But, the time for obtaining such a histogram is typically longer than with a time-of-flight imaging method according to the present disclosure, since for each measurement the whole measurement interval time tₘₐₓ is needed.

In some embodiments, the time-of-flight imaging circuitry is further configured to detect the subset of the events in the second detection.

The second detection may include a plurality of detections, as discussed herein, for example with respect to FIG. 1, such that on the second detection, a third detection, a fourth detection, and so on may follow.

However, according to the present disclosure, at least one of such second detections may start after a predetermined time after a start of the first detection and a subset of events is detected, which are already detected in the first detection.

The predetermined time may be different between each detection, or, in other words: non-uniform delays may be used relative to a previous detection. Thereby, a generated background noise may be decreased and, thus, may be neglectable for determining a distance.

Depending on an application, the respective delays may be adapted. For example, a pattern may be defined or produced according to a generated background noise, such that noise may be filtered, and the like.

In some embodiments, the time-of-flight imaging circuitry is further configured to accumulate the set of events of the first detection and the subset of events of the second detection in a same histogram, as discussed herein. Generally, a histogram may only refer to a representation of the events, such that according to the present disclosure, a bin memory may be updated (partly) simultaneously for different readout channels, as discussed herein.

Hence, in some embodiments, time-of-flight imaging circuitry is further configured to update a plurality of memory bins simultaneously for the first and for the second detection for accumulating the set of events of the first detection and the subset of events of the second detection, as discussed herein.

In some embodiments, an illumination time interval between a first light pulse and a second light pulse of the set of light pulses corresponds to the predetermined time, as discussed herein.

In some embodiments, the imaging element includes a set of imaging sub-elements, as discussed herein.

For example, a macro pixel may correspond to the imaging element and a set of (i.e. at least two) single pixels (or SPADs) of the macro pixel may correspond to the imaging sub-elements. However, the present disclosure is not limited in that regard as a plurality of readout channels may be provided to one single pixel, as well.

In some embodiments, a number of the set of imaging sub-elements corresponds to a number of the set of readout channels.

For example, each imaging sub-element may have exactly one readout channel. Thereby, a noise may be reduced since a signal, which is indicative of the events may not be distributed to multiple channels.

Some embodiments pertain to a time-of-flight imaging system having: a light source; control circuitry configured to control the light source to emit a set of light pulses; and time-of-flight imaging circuitry configured to: control a set of readout channels for an imaging element for obtaining a set of events representing a set of light pulses captured in the imaging element, wherein the controlling includes: a first detection of the set of events in a first readout channel of the set of readout channels; and a second detection in a second readout channel, wherein the second detection starts a predetermined time after the first detection for detecting a subset of the events, as discussed herein.

The light source may be a modulated light source, a pulsed light source, a spotted light source, and the like, and may be configured of at least one laser such as a laser diode, VCSEL (vertical cavity surface emitting laser), and the like, without limiting the present disclosure in that regard.

The control circuitry may correspond to the time-of-flight imaging circuitry, in some embodiments, as it may be provided by the same processor (or set of processors), and the like, whereas, in other embodiments, the control circuitry may be different circuitry.

The emitting of the set of light pulses may be based on a timing, on a predetermined time interval, on an emission pattern, and the like, and may correspond to, be based on or form the basis for the predetermined time between the first and the second detection, as discussed herein.

In some embodiments, the time-of-flight imaging system is further configured to detect the subset of the events in the second detection, as discussed herein. In some embodiments, the time-of-flight imaging circuitry is further configured to: accumulate the set of events of the first detection and the subset of events of the second detection in a same histogram, as discussed herein.

In some embodiments, the time-of-flight imaging system further has a bin memory, and is further configured to update a plurality of memory bins of the memory simultaneously for the first and for the second detection for accumulating the set of events of the first detection and the subset of events of the second detection, as discussed herein.

In some embodiments, an illumination time interval between a first light pulse and a second light pulse of the set of light pulses corresponds to the predetermined time, as discussed herein. In some embodiments, the imaging element includes a set of imaging sub-elements, as discussed herein. In some embodiments, the set of imaging sub-elements corresponds to the set of readout-channels, as discussed herein.

Some embodiments pertain to a time-of-flight imaging method including: controlling a set of readout channels for an imaging element for obtaining a set of events representing a set of light pulses captured in the imaging element, wherein the controlling includes: a first detection of the set of events in a first readout channel of the set of readout channels; and a second detection in a second readout channel, wherein the second detection starts a predetermined time after the first detection for detecting a subset of the events, as discussed herein.

The time-of-flight imaging method may be performed with a time-of-flight imaging circuitry and/or a time-of-flight imaging system according to the present disclosure.

In some embodiments, the time-of-flight imaging method further includes detecting the subset of the events in the second detection, as discussed herein. In some embodiments, the time-of-flight imaging method further includes accumulating the set of events of the first detection and the subset of events of the second detection in a same histogram, as discussed herein. In some embodiments, the time-of-flight imaging method further includes updating a plurality of memory bins simultaneously for the first and for the second detection for accumulating the set of events of the first detection and the subset of events of the second detection, as discussed herein. In some embodiments, an illumination time interval between a first light pulse and a second light pulse of the set of light pulses corresponds to the predetermined time, as discussed herein. In some embodiments, the imaging element includes a set of imaging sub-elements, as discussed herein. In some embodiments, the set of imaging sub-elements corresponds to the set of readout-channels, as discussed herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

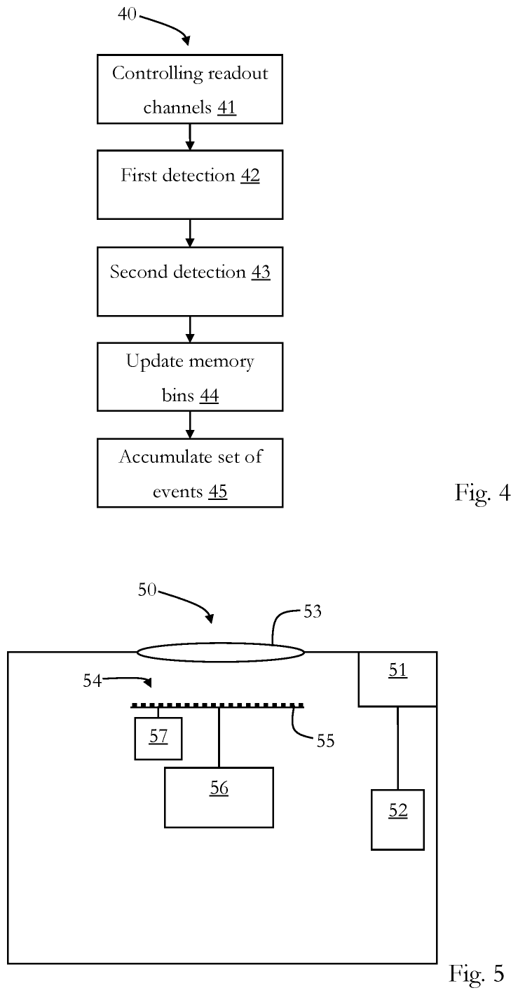

FIG. 4 depicts a time-of-flight imaging method 40 according to the present disclosure in a block diagram.

At 41, a set of readout channels is controlled for an imaging element for obtaining a set of events representing a set of light pulses captured in the imaging element, wherein the controlling includes, at 42, a first detection of the set of events in a first readout channel of the set of readout channels, and, at 43, a second detection in a second readout channel, wherein the second detection starts a predetermined time after the first detection for detecting a subset of the events, wherein, at 43, the subset of the events is detected, as discussed herein.

At 44, a plurality of memory bins is updated simultaneously for the first and for the second detection for accumulating the set of events of the first detection and the subset of events of the second detection, as discussed herein.

At 45, the set of events of the first detection and the subset of events of the second detection is accumulated in the same histogram, as discussed herein.

FIG. 5 depicts a time-of-flight imaging system 50 according to the present disclosure in a block diagram, which may be configured to implement and/or execute a time-of-flight imaging method according to the present disclosure, such as the time-of-flight imaging method 40, which is described under reference of FIG. 4.

The time-of-flight imaging system 50 is adapted as a time-of-flight camera having a light source 51 including a plurality of VCSELs, which are configured to emit modulated light.

Moreover, control circuitry 52 is provided, which is configured to control the light source 51 to emit a plurality of light pulses according to a predetermined light pulse emission pattern.

Furthermore, the time-of-flight imaging system 50 includes a lens stack 53 being configured to focus light onto a time-of-flight image sensor 54 including a plurality of pixels 55. The pixels 55 include SPADs and each pixel 55 is configured to perform an electric conversion, such that an event can be detected

The time-of-flight imaging system 50 further includes time-of-flight imaging circuitry 56 according to the present disclosure, which is, in this embodiment adapted as a CPU, and is configured to execute a time-of-flight imaging method according to the present disclosure, such as the time-of-flight imaging method 40, as described under reference of FIG. 4, without limiting the present disclosure in that regard.

The time-of-flight imaging circuitry is, hence, configured to control a plurality of readout channels, of which each pixel includes one, such that a plurality of bins of a bin memory 57 is simultaneously updated, as discussed herein.

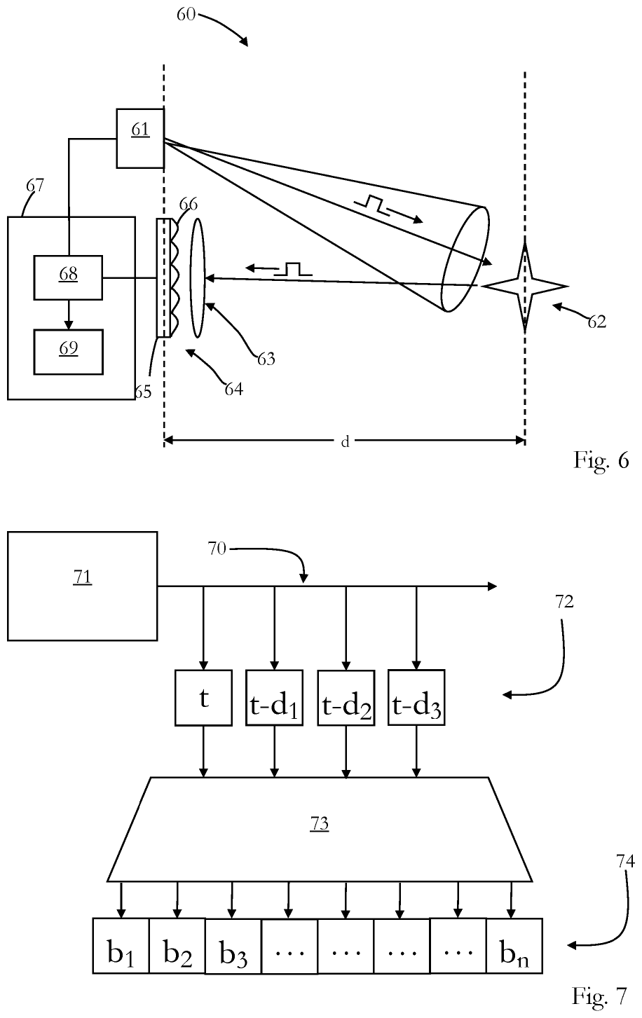

In FIG. 6, on a high level, there is illustrated an embodiment of a time-of-flight imaging system 60, which is embodied here as a dToF camera and which can be used for depth sensing or providing a distance measurement and which has time-of-flight imaging circuitry 67 which is configured to perform the methods as discussed herein and which forms a control of the ToF apparatus 60 (and it includes, not shown, corresponding processors, memory and storage as it is generally known to the skilled person).

The ToF apparatus 60 has a pulsed light source 61 and it includes light emitting elements (based on laser diodes), wherein in the present embodiment, the light emitting elements are narrow band laser elements.

The light source 61 emits pulsed light to a scene 62 (region of interest or object), which reflects the light. By repeatedly emitting light to the scene 62, the scene 62 can be scanned, as it is generally known to the skilled person. The reflected light is focused by an optical stack 63 to a light detector 64.

The time-of-flight imaging circuitry 67 also forms control of the light source, such that it also includes a control circuitry, as discussed herein.

The light detector 64 has an image sensor 65, which is implemented based on multiple SPADs (Single Photon Avalanche Diodes) formed in an array of pixels (imaging elements) and a microlens array 66 which focuses the light reflected from the scene 62 to the image sensor 65 (to each pixel of the image sensor 65).

The light emission time information is fed from the light source 61 to the time-of-flight imaging circuitry 67 including a time-of-flight measurement unit 68, which also receives respective time information from the image sensor 65, when the light is detected which is reflected from the scene 62. On the basis of the emission time information received from the light source 61 and the time of arrival information received from the image sensor 65, the time-of-flight measurement unit 68 computes a round-trip time of the light emitted from the light source 61 and reflected by the scene 62 and on the basis thereon it computes a distance d (depth information) between the image sensor 65 and the scene 62 based on a detection of events, as discussed herein.

The depth information is fed from the time-of-flight measurement unit 68 to a 3D image reconstruction unit 69 of the time-of-flight imaging circuitry 67, which reconstructs (generates) a 3D image of the scene 62, based on the depth information received from the time-of-flight measurement unit 68.

FIG. 7 depicts a further embodiment of a time-of-flight imaging system 70 according to the present disclosure in a block diagram, which are also implemented in the systems of FIGS. 5 and 6, in some embodiments.

The time-of-flight imaging system 70 includes a macro pixel 71, four readout channels 72, time-of-flight imaging circuitry 73, and a bin memory 74 including a plurality of bins bᵢ, wherein i lies between 1 and n.

The macro pixel 71 outputs a number of events for each time instance and is configured of four SPADs, wherein to each SPAD a respective readout channel 72 is assigned.

The left (first) readout channel is controlled, by the time-of-flight imaging circuitry 73, to output a number of events at the time instance t. The second readout channel (from the left) has a delay of d₁, the third readout channel (from the left) has a delay of d₂, and the right readout channel has a delay of d₃, wherein the delays are non-uniform, as discussed herein, and wherein the delays are based on a master clock (not depicted), as discussed above, and correspond to the predetermined time and also the time interval between the to be detected light pulses.

The time-of-flight imaging circuitry 73 is configured to simultaneously update the bins of the bin memory 74 according to a detected event of any of the readout channels, such that an accumulated histogram is generated, as it has also been discussed under reference of FIG. 1 and FIG. 2, wherein the resulting histogram may exemplarily correspond to the histogram of FIG. 2.

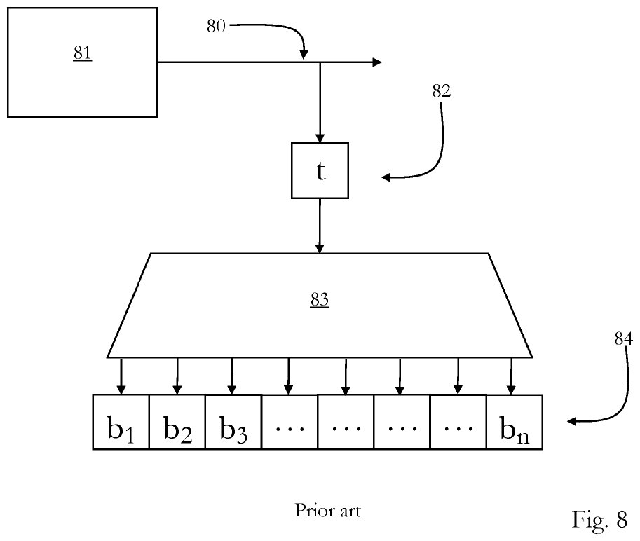

In contrast to this, a time-of-flight imaging system 80, as it is known in the art, is depicted in a block diagram of FIG. 8.

A macro pixel 81 includes one SPAD, which is associated with a readout channel 82. A time-of-flight imaging circuitry 83 is configured to read events of a single measurement of the macro pixel 81 from the readout circuitry and update a bin memory 84 to generate a histogram.

After that, the bin memory 84 is reset based on a master clock (not depicted) and a new measurement (or multiple new measurements) is (are) performed, and after that the generated histograms are merged.

It should be recognized that the embodiments describe methods with an exemplary ordering of method steps. The specific ordering of method steps is however given for illustrative purposes only and should not be construed as binding. For example, the ordering of 42 and 43 in the embodiment of FIG. 4 may be exchanged. Other changes of the ordering of method steps may be apparent to the skilled person.

Please note that the division of the time-of-flight imaging circuitry 67 into units 68 to 69 is only made for illustration purposes and that the present disclosure is not limited to any specific division of functions in specific units. For instance, the time-of-flight imaging circuitry 67 could be implemented by a respective programmed processor, field programmable gate array (FPGA) and the like.

The methods can also be implemented as a computer program causing a computer and/or a processor, to perform the methods, when being carried out on the computer and/or processor. In some embodiments, also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) A time-of-flight imaging circuitry configured to:
control a set of readout channels for an imaging element for obtaining a set of events representing a set of light pulses captured in the imaging element, wherein the controlling includes:
a first detection of the set of events in a first readout channel of the set of readout channels; and
a second detection in a second readout channel, wherein the second detection starts a predetermined time after a start of the first detection for detecting a subset of the events.

(2) The time-of-flight imaging circuitry (1), further configured to:
detect the subset of the events in the second detection.

(3) The time-of-flight imaging circuitry of anyone of (1) and (2), further configured to:
accumulate the set of events of the first detection and the subset of events of the second detection in a same histogram.

(4) The time-of-flight imaging circuitry of (3), further configured to:
update a plurality of memory bins simultaneously for the first and for the second detection for accumulating the set of events of the first detection and the subset of events of the second detection.

(5) The time-of-flight imaging circuitry of anyone of (1) to (4), wherein an illumination time interval between a first light pulse and a second light pulse of the set of light pulses corresponds to the predetermined time.

(6) The time-of-flight imaging circuitry of anyone of (1) to (5), wherein the imaging element includes a set of imaging sub-elements.

(7) The time-of-flight imaging circuitry of (6), wherein a number of the set of imaging sub-elements corresponds to a number of the set of readout-channels.

(8) A time-of-flight imaging system comprising:
a light source;
control circuitry configured to control the light source to emit a set of light pulses; and
time-of-flight imaging circuitry configured to:
control a set of readout channels for an imaging element for obtaining a set of events representing a set of light pulses captured in the imaging element, wherein the controlling includes:
a first detection of the set of events in a first readout channel of the set of readout channels; and
a second detection in a second readout channel, wherein the second detection starts a predetermined time after the first detection for detecting a subset of the events.

(9) The time-of-flight imaging system of (8), further configured to:
detect the subset of the events in the second detection.

(10) The time-of-flight imaging system of anyone of (8) and (9), further configured to:
accumulate the set of events of the first detection and the subset of events of the second detection in a same histogram.

(11) The time-of-flight imaging system of (10), further comprising a bin memory, and being further configured to:
update a plurality of memory bins of the bin memory simultaneously for the first and for the second detection for accumulating the set of events of the first detection and the subset of events of the second detection.

(12) The time-of-flight imaging system of anyone of (8) to (11), wherein an illumination time interval between a first light pulse and a second light pulse of the set of light pulses corresponds to the predetermined time.

(13) The time-of-flight imaging system of anyone of (8) to (12), wherein the imaging element includes a set of imaging sub-elements.

(14) The time-of-flight imaging system of (13), wherein the set of imaging sub-elements corresponds to the set of readout-channels.

(15) A time-of-flight imaging method comprising:
controlling a set of readout channels for an imaging element for obtaining a set of events representing a set of light pulses captured in the imaging element, wherein the controlling includes:
a first detection of the set of events in a first readout channel of the set of readout channels; and
a second detection in a second readout channel, wherein the second detection starts a predetermined time after the first detection for detecting a subset of the events.

(16) The time-of-flight imaging method of claim (15), further configured to:
detecting the subset of the events in the second detection.

(17) The time-of-flight imaging method of claim anyone of (15) and (16), further configured to:
accumulating the set of events of the first detection and the subset of events of the second detection in a same histogram.

(18) The time-of-flight imaging method of (17), further configured to:
updating a plurality of memory bins simultaneously for the first and for the second detection for accumulating the set of events of the first detection and the subset of events of the second detection.

(19) The time-of-flight imaging method of anyone of (15) to (18), wherein an illumination time interval between a first light pulse and a second light pulse of the set of light pulses corresponds to the predetermined time.

(20) The time-of-flight imaging method of anyone of (15) to (19), wherein the imaging element includes a set of imaging sub-elements, wherein the set of imaging sub-elements corresponds to the set of readout-channels.

(21) A computer program comprising program code causing a computer to perform the method according to anyone of (11) to (20), when being carried out on a computer.

(22) A non-transitory computer-readable recording medium that stores therein a computer program product, which, when executed by a processor, causes the method according to anyone of (11) to (20) to be performed.

1. A time-of-flight imaging circuitry configured to:
control a set of readout channels for an imaging element for obtaining a set of events representing a set of light pulses captured in the imaging element, wherein the controlling includes:
a first detection of the set of events in a first readout channel of the set of readout channels; and
a second detection in a second readout channel, wherein the second detection starts a predetermined time after a start of the first detection for detecting a subset of the events.

2. The time-of-flight imaging circuitry of claim 1, further configured to:
detect the subset of the events in the second detection.

3. The time-of-flight imaging circuitry of claim 2, further configured to:
accumulate the set of events of the first detection and the subset of events of the second detection in a same histogram.

4. The time-of-flight imaging circuitry of claim 3, further configured to:
update a plurality of memory bins simultaneously for the first and for the second detection for accumulating the set of events of the first detection and the subset of events of the second detection.

5. The time-of-flight imaging circuitry of claim 1, wherein an illumination time interval between a first light pulse and a second light pulse of the set of light pulses corresponds to the predetermined time.

6. The time-of-flight imaging circuitry of claim 1, wherein the imaging element includes a set of imaging sub-elements.

7. The time-of-flight imaging circuitry of claim 6, wherein a number of the set of imaging sub-elements corresponds to a number of the set of readout-channels.

8. A time-of-flight imaging system comprising:
a light source;
control circuitry configured to control the light source to emit a set of light pulses; and
time-of-flight imaging circuitry configured to:
control a set of readout channels for an imaging element for obtaining a set of events representing a set of light pulses captured in the imaging element, wherein the controlling includes:
a first detection of the set of events in a first readout channel of the set of readout channels; and
a second detection in a second readout channel, wherein the second detection starts a predetermined time after the first detection for detecting a subset of the events.

9. The time-of-flight imaging system of claim 8, further configured to:
detect the subset of the events in the second detection.

10. The time-of-flight imaging system of claim 9, further configured to:
accumulate the set of events of the first detection and the subset of events of the second detection in a same histogram.

11. The time-of-flight imaging system of claim 10, further comprising a bin memory, and being further configured to:
update a plurality of memory bins of the bin memory simultaneously for the first and for the second detection for accumulating the set of events of the first detection and the subset of events of the second detection.

12. The time-of-flight imaging system of claim 8, wherein an illumination time interval between a first light pulse and a second light pulse of the set of light pulses corresponds to the predetermined time.

13. The time-of-flight imaging system of claim 8, wherein the imaging element includes a set of imaging sub-elements.

14. The time-of-flight imaging system of claim 13, wherein the set of imaging sub-elements corresponds to the set of readout-channels.

15. A time-of-flight imaging method comprising:
controlling a set of readout channels for an imaging element for obtaining a set of events representing a set of light pulses captured in the imaging element, wherein the controlling includes:
a first detection of the set of events in a first readout channel of the set of readout channels; and
a second detection in a second readout channel, wherein the second detection starts a predetermined time after the first detection for detecting a subset of the events.

16. The time-of-flight imaging method of claim 15, further configured to:
detecting the subset of the events in the second detection.

17. The time-of-flight imaging method of claim 15, further configured to:
accumulating the set of events of the first detection and the subset of events of the second detection in a same histogram.

18. The time-of-flight imaging method of claim 17, further configured to:
updating a plurality of memory bins simultaneously for the first and for the second detection for accumulating the set of events of the first detection and the subset of events of the second detection.

19. The time-of-flight imaging method of claim 15, wherein an illumination time interval between a first light pulse and a second light pulse of the set of light pulses corresponds to the predetermined time.

20. The time-of-flight imaging method of claim 15, wherein the imaging element includes a set of imaging sub-elements, wherein the set of imaging sub-elements corresponds to the set of readout-channels.
